(19) United States
(12) Patent Application Publication
(10) Pub. No.: US 2026/0019305 A1
(43) Pub. Date: Jan. 15, 2026

(54) METHODS TO ESTIMATE CHANNEL USING A SINGLE PILOT IN A WIRELESS COMMUNICATION SYSTEM

(71) Applicants: CENTRE OF EXCELLENCE IN WIRELESS TECHNOLOGY, Tamil Nadu (IN); INDIAN INSTITUTE OF TECHNOLOGY MADRAS (IIT MADRAS), Tamil Nadu (IN)

(72) Inventors: Sonil Baberwal, Tamil Nadu (IN); Priyanka Dey, Tamil Nadu (IN); Deepak Padmanabhan Mayakumari, Tamil Nadu (IN); Jeniston Deviraj Klutto Milleth, Tamil Nadu (IN); Bhaskar Ramamurthi, Tamil Nadu (IN)

(73) Assignees: CENTRE OF EXCELLENCE IN WIRELESS TECHNOLOGY, Tamil Nadu (IN); INDIAN INSTITUTE OF TECHNOLOGY MADRAS (IIT MADRAS), Tamil Nadu (IN)

(21) Appl. No.: 19/267,107

(22) Filed: Jul. 11, 2025

(30) Foreign Application Priority Data
Jul. 11, 2024 (IN) 202441053041

(51) Int. Cl. H04L 25/02; H04L 5/00; H04L 27/34

(52) U.S. Cl. CPC H04L 25/0202; H04L 5/0048; H04L 27/34

(57) ABSTRACT

The disclosed methodology provides a methodology to estimate channel using a single pilot symbol in a wireless communication. According to an embodiment, the method includes receiving, by a node, a plurality of modulated data symbols, and a pilot symbol. Further, the method includes determining, by the node, at least one first centroid point corresponding to the plurality of modulated data symbols. Further, the method includes determining, by the node, a distance between the pilot symbol and each of the at least one first centroid point. Further, the method includes selecting, by the node, a second centroid point from the at least one first centroid point, wherein the second centroid point is the first centroid point with a minimum distance from the pilot symbol. Further, the method includes estimating, by the node, the channel based on the second centroid point and at least one information about the pilot symbol.

### CROSS REFERENCE TO RELATED APPLICATIONS

The present application claims the benefit of priority under 35 USC Section 119 to Indian Patent Application No. 202441053041, filed on Jul. 11, 2024.

### FIELD OF INVENTION

The present disclosure provides a methodology to estimate channel in a wireless communication. In particular, the disclosed methodology provides a methodology to estimate channel using a single pilot symbol in the wireless communication.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Channel estimation plays a major role in the detection of the transmitted data at the receiver in wireless systems. The channel estimation involves the crucial task of determining the communication channel between the transmitter and the receiver. In communication systems, reference signals (RS) or pilot symbols are transmitted to estimate the channel at the receiver. The quality of channel estimation depends on various factors like signal to interference plus noise ratio (SINR), type of the RS, density of the RS used, algorithm for estimating the channel, etc. The 5G new radio (NR) technology employs dedicated reference signals known as demodulation reference signals (DMRS) for channel estimation during data detection. The DMRS are specific known sequence transmitted along with the data stream by the transmitter. Typically, four to six time-frequency resources are used for DMRS within a block of one OFDM symbol and 12 subcarriers. The channel estimated based on the DMRS is used for equalizing the block assuming channel remains constant within the block. However, minimizing the number of resources for RSs to one for the whole block would increase the number of resources for data transmission to the fullest. The accuracy of the channel thus estimated would be very poor due to no noise averaging, however, the knowledge of all the data symbols transmitted in the block can be used for noise averaging. This would ensure an accurate estimate of the channel.

Thus, there is a need to develop a methodology to estimate channel using a single pilot symbol.

Through applied effort, ingenuity, and innovation, the inventors have solved and proposed the above problem(s) by developing the solutions embodied in the present disclosure, the details of which are described further herein.

### SUMMARY OF THE INVENTION

In general, embodiments of the present disclosure herein provide a method for estimating a channel in a wireless communication system. Other implementations will be or will become apparent to one with skill in the art upon examination of the following figures and detailed description. It is intended that all such additional implementations be included within this description within the scope of the disclosure.

The present disclosure provides a method for estimating a channel in a wireless communication system. According to an embodiment of the present disclosure, the method includes receiving, by a node, a plurality of modulated data symbols, and a pilot symbol. Further, the method includes determining, by the node, at least one first centroid point corresponding to the plurality of modulated data symbols. Further, the method includes determining, by the node, a distance between the pilot symbol and each of the at least one first centroid point. Further, the method includes selecting, by the node, a second centroid point from the at least one first centroid point, wherein the second centroid point is the first centroid point with a minimum distance from the pilot symbol. Further, the method includes estimating, by the node, the channel based on the second centroid point and at least one information about the pilot symbol.

The above summary is provided merely for the purpose of summarizing some exemplary embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject will become apparent from the description, the drawings, and the claims.

### DESCRIPTION OF THE DRAWINGS

Having thus described the embodiments of the disclosure in general terms, reference now will be made to the accompanying drawings, which are not necessarily drawn to scale, and wherein:

FIG. 1 illustrates a block diagram of a transmitter and a receiver of a channel estimation using a single RS or a pilot symbol, according to an embodiment of the present disclosure;

FIG. 2 illustrates a scenario when the difference between the angle of the nearest centroid point and transmitted pilot symbol is negative, according to an embodiment of the present disclosure;

FIG. 3 illustrates a scenario when the difference between the angle of the nearest centroid point and transmitted pilot symbol is positive, according to an embodiment of the present disclosure;

FIGS. 4 and 5 illustrates an example of determination of various parameters for 16 QAM constellation, according to an embodiment of the present disclosure;

FIG. 6 illustrates a method for estimating a channel in a wireless communication system, according to an embodiment of the present disclosure; and

FIG. 7 illustrates a general block diagram of the node, according to an embodiment of the present disclosure.

### DESCRIPTION OF THE INVENTION

The description set forth below in connection with the appended drawings is intended as a description of various embodiments of the present invention and is not intended to represent the only embodiments in which the present invention may be practiced. Each embodiment described in this invention is provided merely as an example or illustration of the present invention, and should not necessarily be construed as preferred or advantageous over other embodiments. The description includes specific details for the purpose of providing a thorough understanding of the present invention. However, it will be apparent to those skilled in the art that the present invention may be practiced without these specific details. Further, the reference numerals for similar components, modules, units, and operation steps have been kept the same for the ease of understanding.

Some embodiments of the present disclosure will now be described with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements.

According to an embodiment, a method for estimating channel using AI/ML based channel estimation algorithms by using only a single RS/pilot symbol is disclosed. Estimating the channel using a single RS/pilot symbol offers a balance between overhead reduction, spectral efficiency, complexity, and robustness, making it a valuable approach in certain wireless communication scenarios.

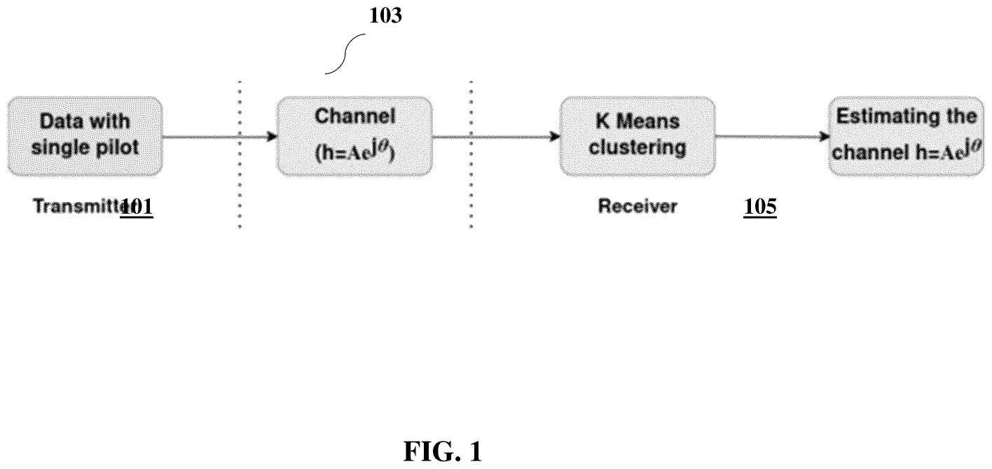

FIG. 1 illustrates a block diagram of a transmitter and a receiver of a channel estimation using a single RS or a pilot symbol, according to an embodiment of the present disclosure. According to an embodiment, at the transmitter 101, a single pilot symbol is inserted into the data stream before transmission. For example, in an OFDM system, the single pilot can be a QPSK modulated symbol in one time-frequency resource of the OFDM grid. The transmitted signal propagates through the wireless channel 103 that can be represented in the form of h=Ae^{jθ}, where A and θ are the magnitude and phase of the channel, respectively.

In an embodiment, at the receiver 105, the modulated symbols (also known as the data points) of the received OFDM symbol are divided into M clusters using a K− means clustering algorithm and a centroid is estimated. In an embodiment, the value of ‘M’ is depends on the modulation order of the transmitted symbols. E.g., if the modulated symbols are from the QPSK constellation, then the value of M is 4. if the modulated symbols are from the 16 QAM constellation, then the value of M is 16. According to an embodiment, the information about the modulation order is provided to the receiver 105 by the transmitter 101 or some other node or detected at the receiver by an AI/ML based modulation classification techniques, or specified in the standards, or by some other means.

In an embodiment, without the effect of channel and thermal noise, the estimated centroids should coincide with the transmitted constellation. However, the amplitude and phase of the symbols are changed due to the effect of channel fading and noise. Hence, the estimated centroids will be different from the transmitted constellation. The information about the transmitted pilot symbol, e.g., modulation order, power, quadrant information, time-frequency resource, is available at the receiver 105 either from the transmitter 101 or obtained at/by the receiver 105 using some other means or pre-defined in the specification. Assuming all the data points experience the same channel and based on the data points, the estimated centroids and the RS/pilot symbol received, channel estimation is performed. The different methods of estimating the channel are described below. The magnitude ‘A’ of the channel Ae^{jθ} is estimated by averaging the amplitudes of the estimated centroids with similar magnitude order. The magnitudes will be the constant for constant amplitude modulations and will be piecewise constant in the case of non-constant magnitude modulations. According to an embodiment, the phase ‘θ’ of the channel is estimated using any of the following methods as described in the forthcoming paragraphs.

According to some embodiments, the method for determining phase ‘θ’ of the channel for a received QPSK modulated symbol will be explained in the forthcoming paragraph.

In an embodiment, at first an angle ‘θₜₚ’ of transmitted pilot symbol with respect to the real axis (x-axis) is determined. In an embodiment, the transmitted pilot symbol with unit magnitude is represented in polar form as e^{j(θtp)}, where the angle θₜₚ is measured in radians. Similarly, the angle can be measured in degrees as well, then the angle in radians should be substituted by angle in degrees in the different methods described in this disclosure. This angle represents the direction of the transmitted pilot symbol in the complex plane relative to the real axis. After determining the angle of the transmitted pilot symbol, at the next step the angle of a nearest centroid point with respect to the real axis is determined. Further, the phase of the channel is calculated based on the angle of transmitted pilot symbol, angle of the nearest centroid point. The detailed operation is given as below.

Step 1—Determine the angle ‘θₜₚ’ of transmitted pilot symbol with respect to the real axis (x-axis).
At the transmitter 101, a single pilot symbol is inserted into the data stream before transmission. E.g., in an OFDM system, a single pilot symbol can be a QPSK modulated symbol in one time-frequency resource of the OFDM grid.
Compute the angle of transmitted pilot symbol. This angle represents the position of the pilot symbol in the complex plane relative to the real axis.
The transmitted signal propagates through the wireless channel that can be represented in the form of h=Ae^{jθ}, where A and θ are the magnitude and phase of the channel, respectively.

Step 2—Determine the angle of nearest centroid point with respect to the real axis.
At the receiver 105, the modulated symbols (also known as the data points) are divided into M clusters using a K− means clustering algorithm and centroid is estimated.
The distances between the received pilot symbol and each centroid point are computed. These distances are calculated using methods like Euclidean distance, depending on the system's specific requirements. These distances are used to determine which centroid point is the nearest to the received pilot symbol.
After identifying the centroid point closest to the received pilot symbol (generally, the centroid point with the minimum distance obtained), the angle ‘Q_{ec}’ of this estimated centroid point with respect to the real axis is determined. This angle represents the position of the nearest centroid point in the complex plane.

Step 3—The phase of the channel is calculated based on the angle of transmitted pilot symbol ‘θₜₚ’, and angle of the nearest centroid point ‘θ_{ec}’ is given by:
Compute the difference between the angle of the nearest centroid point and transmitted pilot symbol.
   If the difference is positive than computed difference is the phase of the channel
   if difference is negative than 2π is added to the difference.

In an embodiment, computing the difference between the angle of the nearest centroid point and transmitted pilot symbol is given by

$$\begin{matrix}{θ}_{e c} - {θ}_{tp} & when {θ}_{ec} - {θ}_{tp} > 0 and\end{matrix} \qquad ( 1 )$$

$$\begin{matrix}{θ}_{e c} - {θ}_{tp} + 2 π & when {θ}_{ec} - {θ}_{tp} < 0\end{matrix} \qquad ( 2 )$$

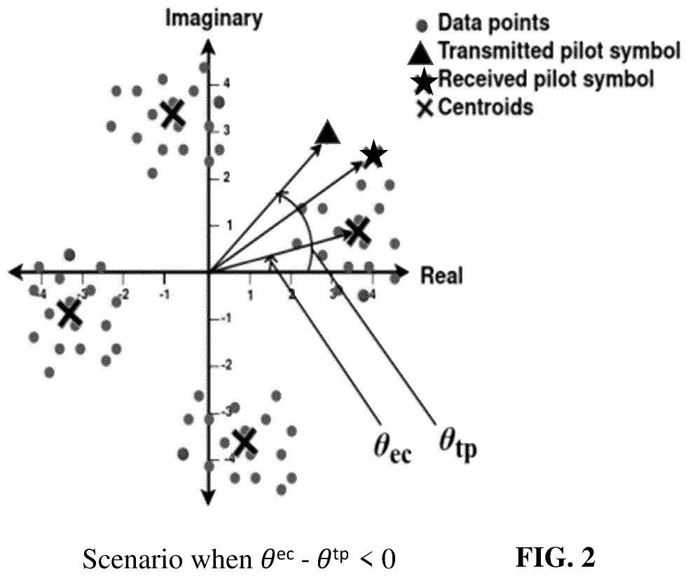

FIG. 2 illustrates a scenario when the difference between the angle of the nearest centroid point and transmitted pilot symbol is negative, according to an embodiment of the present disclosure. As can be seen from FIG. 2, the location of the centroid points is marked as ‘x’ and received pilot symbol is marked as ‘★’ in the complex plane. The nearest centroid point is the centroid point closer to the received pilot symbol. The difference between the angles of the nearest centroid point ‘θ_{ec}’ and the transmitted pilot symbol ‘θₜₚ’ is calculated by using equation (1) and (2). In an embodiment, the difference between the angles of the nearest centroid point ‘B_{ec}’ and the transmitted pilot symbol ‘θₜₚ’ is negative then 2π is added to the difference value.

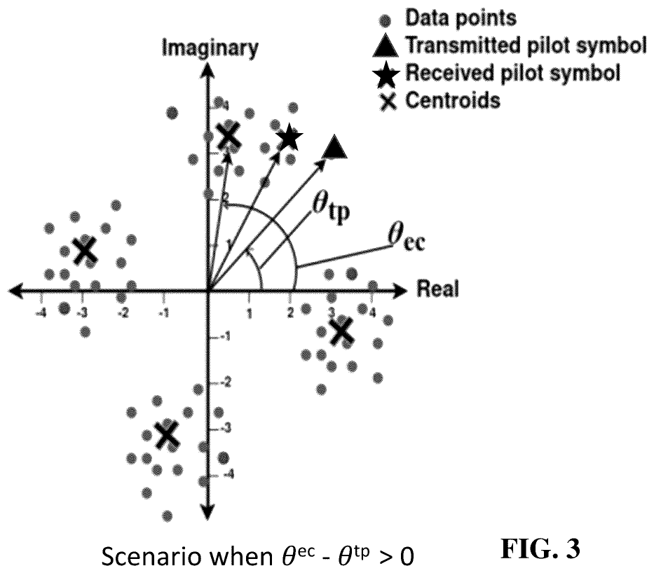

FIG. 3 illustrates a scenario when the difference between the angle of the nearest centroid point and transmitted pilot symbol is positive, according to an embodiment of the present disclosure. As can be seen from the FIG. 3, the location of the centroid points is marked as ‘x’ and received pilot symbol is marked as colored ‘★’ in the complex plane. The nearest centroid point is the centroid point closer to the received pilot symbol. The difference between the angles of the nearest centroid point ‘θ_{ec}’ and the transmitted pilot symbol ‘θₜₚ’ is calculated by using equation (1) and (2).

According to some embodiments, the method for determining phase ‘0’ of the channel for a received QAM constellation will be explained in the forthcoming paragraph. As an example, the QAM having 16 QAM constellation is being explained here for description purpose.

In an embodiment, at first an angle ‘θₜₚ’ of transmitted pilot symbol with respect to the real axis (x-axis) is determined. Further, the angle of each centroid points and nearest centroid point with respect to the real axis is determined. Further, a number of the rings in a complex plane is determined. Further, a rotation angle of a ring is determined. Further, an average of the rotation angle of rings is determined. Further, the number corresponding to transmitted pilot symbol in the ring is determined. Further, a number corresponding to nearest centroid point in the ring is determined. Further, the phase of the channel is calculated from the angle of transmitted pilot symbol, the angle of the nearest centroid point, rotation angle and number of centroid points in the ring in the complex plane are determined. The detailed operation is given as below.

Step 1—Determine the angle ‘θₜₚ’ of transmitted pilot symbol with respect to the real axis (x-axis).
At the transmitter 101, a single pilot symbol is inserted into the data stream before transmission. For example, in an OFDM system, a single pilot symbol can be a QPSK modulated symbol in one time-frequency resource of the OFDM grid.
Compute the angle of transmitted pilot symbol. This angle represents the position of the transmitted pilot symbol in the complex plane relative to the real axis.
The transmitted signal propagates through the wireless channel that can be represented in the form of h=Ae^{jθ}, where A and θ are the magnitude and phase of the channel, respectively.

The transmitted and received pilot symbols with unit magnitude are represented in polar form as e^{j(θtp)} and e^{j(θrp)}, respectively, where the angle θₜₚ and θᵣₚ are measured in radians. Similarly, the angle can be measured in degrees as well, then the angle in radians should be substituted by angle in degrees in the different methods described in this invention. These angles represent the direction of the transmitted pilot symbol and received pilot symbol respectively in the complex plane relative to the real axis.

Step 2—Determine the angle of each centroid points θ_{mc}, for m=1, 2, . . . M, where M is the modulation order. Further determine the nearest centroid point with respect to the real axis.
At the receiver 105, the modulated symbols (also known as the data points) are divided into M clusters using a K− means clustering algorithm and a centroid is estimated. The angle of centroid point is computed with respect to the real axis.
   M depends on the modulation order of the transmitted symbols. E.g., if the modulated symbols are from the QPSK constellation, then the value of M is 4. if the modulated symbols are from the 16 QAM constellation, then the value of M is 16.
The distances between the received pilot symbol and each centroid point are computed. These distances are calculated using methods like Euclidean distance, depending on the system's specific requirements. These distances are used to determine which centroid point is the nearest to the received pilot symbol.
After identifying the centroid point closest to the received pilot symbol, the angle of this centroid point with respect to the real axis is determined. This angle represents the position of the nearest centroid point in the complex plane.

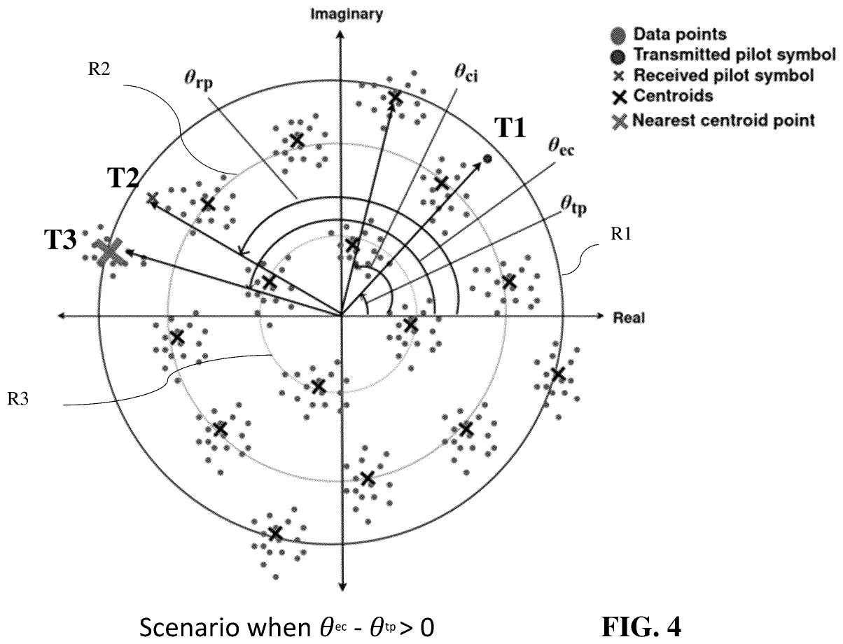

FIG. 4 illustrates an example of determination of various parameters for 16 QAM constellation, according to an embodiment of the present disclosure. FIG. 4 shows the angle θ_{ci} which is the angle of the centroid points from the origin in the ring j with respect to the real axis (x axis) in each of the four quadrants in the complex plane.

Step 3—Determine the number of the rings in a complex plane.
The number of the rings depends on the modulation order. For example, if the modulation order is 4 than number of ring is “one” and number of centroid points are 4 in that ring, if the modulation order is 16 than the number of rings are 3 and number of centroid points in the rings are 16 (4 centroid point in first ring (inner ring), 8 in second ring (middle ring), 4 in third ring (outer ring).

The number of rings in a complex plane is denoted by ‘n’. For the modulation order M=4,16,32,64, the number of rings are n=1,3,5,9 respectively. According to an example embodiment, the order of the known pilot symbol (transmitted pilot symbol) in the ring is number corresponding to known pilot symbol. For example, it starts from the first quadrant and continues sequentially up to number of centroid point in the ring. for e.g., if number of centroid point in a ring is 8 than the pilot number starts from 1 and continues sequentially up to 8. the order of known pilot symbol will be one of the values from 1 to 8. According to an exemplary embodiment, if M=16 then number of the rings will be three. These rings are shown in FIG. 4 as R1, R2, and R3 respectively. The pilot number, denoted as Pa, starts from the first quadrant and sequentially continues up to the number of centroid points in the ring. For e.g., in the R1 ring the pilot numbers range from P1 to P4 and in the R2 ring the pilot numbers range from P1 to P8 as shown in FIG. 4. The centroid numbers, denoted as C_{b}, also start from the first quadrant and continue sequentially. For example, in the R1 ring pilot numbers range from C1 to C4 and in the R2 ring the pilot numbers range from C1 to C8 as shown in FIG. 4.

Step 4—Determine the rotation angle of a ring ‘θ_{rc,j}’.
The rotation angle of a ring ‘_{rc,j}’ computed by comparing the angle of centroid points (step 2) in that ring with the transmitted pilot symbol. By comparing the centroid's phases θ_{ci} with the transmitted symbol rotation angle, ‘r_{c,j}’ is determined. The θ_{rc,j} given by equation (3), where j=1 to n, here k is no. of centroid points in ring.

$$( ( {\sum }_{i = 1}^{k} {θ}_{ci , j} ) / k ) \cdot π \qquad ( 3 )$$

Symbols closer to the origin in a constellation diagram are more likely prone to errors in communication systems with low SINR. This susceptibility arises from their lower amplitudes, which make them more vulnerable to noise. Since the signal power of these symbols is comparable to the power of the interference plus noise or noise, interference plus noise or noise addition can significantly affect their accuracy. Conversely, symbols located farther from the origin exhibit higher amplitudes, resulting in stronger signal power and consequently higher SINR. In FIG. 4, for instance, the symbol positioned farthest from the origin near the red ring is less prone to interference plus noise or noise compared to the symbol nearer to the yellow ring. The rotation angle can be determined by considering only one ring. Although symbols closer to the origin are more prone to errors, they still carry information. Therefore, while computing the rotation angle, the accuracy can be improved by considering the rotation angle θ_{rc,j} of every ring. This acknowledgment accounts for the varying SINR of symbols within the constellation. ‘θᵣ’ is the average of rotation angles of each ring. The resulting rotation of angle θᵣ.

$${θ}_{r} = {\sum }_{j = 1}^{n} {θ}_{rc , j} {p}_{j} ; for j = 1 to n \qquad ( 4 )$$

$${p}_{j} is the weighing factor ; if n is equiprobable than {p}_{j} = 1 / n .$$

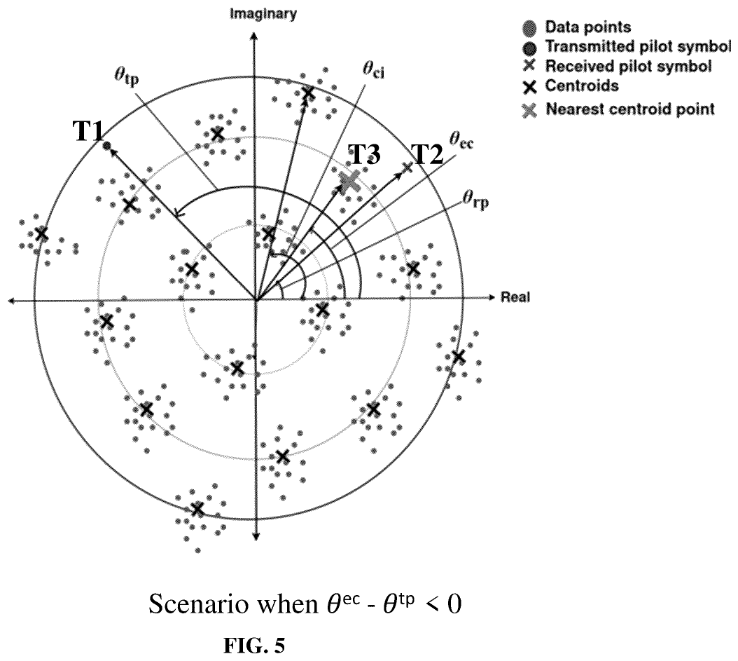

The distances between the received pilot symbol and each of the centroid points are computed. These distances are calculated using methods like Euclidean distance, depending on the system's specific requirements. These distances are used to determine which centroid point is the nearest to the received pilot symbol. After identifying the centroid point nearest to the received pilot symbol (generally, the centroid point with the minimum distance). The angle ‘θ_{ec}’ of this estimated centroid point with respect to the real axis is determined. This angle represents the direction of the nearest centroid point in the complex plane. The phase of the channel is calculated based on the angle of rotation, angle of nearest centroid point, angle of transmitted pilot symbol and the direction of the received pilot symbol in complex plane. The phase of the channel is calculated from the angle of transmitted pilot symbol ‘θₜₚ’, the angle of the nearest centroid point ‘θ_{ec}’, rotation of the angle ‘θᵣ’ and number of centroid points in the ring in the complex plane and is given by

$${θ}_{\text{?}} + ( b - a ) π / 2 q ; \\ for a , b = 1 to No . of centroid point in a ring when {θ}_{ec} - {θ}_{tp} > 0 and \qquad ( 5 )$$

$${θ}_{\text{?}} + ( ( b - a ) π / 2 q ) + 2 π ; \\ for a , b = 1 to No . of centroid point in a ring when {θ}_{ec} - {θ}_{tp} < 0 \qquad ( 6 )$$

$$\text{?} \text{indicates text missing or illegible when filed}$$

Where, q=Number of centroid points in the ring/4. ‘a’ represents the number corresponding to the transmitted pilot symbol and ‘b’ represents the number corresponding to the nearest centroid point. FIG. 4 and FIG. 5 show the location of the transmitted pilot symbol marked as T1, nearest centroid point marked as T3 and received pilot symbol marked as T2 in the complex plane. The nearest centroid point is the centroid point marked as T3 nearer to the received pilot symbol marked as T2.

In FIG. 4, θ_{ec}−θₜₚ>θ, implies phase of the nearest centroid point is greater than the phase of the transmitted pilot symbol. In this scenario, the phase of the channel is computed by using equation (5). In FIG. 5, θ_{ec}−θₜₚ<0, implies phase of the nearest centroid point is less than the phase of the transmitted pilot symbol. In this scenario, the phase of the channel is computed by using equation (6). Similar explanation will hold good for all the other scenarios.

Step 5—Determine the average of rotation angle of rings
The rotation angle can be determined by considering only one ring. Although symbols closer to the origin are more prone to errors, they still carry information. Therefore, while computing the rotation angle, the accuracy can be improved by considering the rotation angle of every ring.
The rotation angle is determined by the average of rotation angle of rings.

Step 6—Determine the number corresponding to transmitted pilot symbol in a ring. (basically pilot number)
It starts from the first quadrant and continues up to the number of centroid points in the ring. For e.g. in the first ring pilot numbers range from 1 to 4, in the second ring pilot numbers range from 1 to 8.

Step 7—Determine the number corresponding to nearest centroid point in a ring.
Centroid point numbers start from the first quadrant and continue sequentially.

Step 8—The phase of the channel is calculated from the angle of transmitted pilot symbol, the angle of the nearest centroid point, rotation angle and number of centroid points in the ring in the complex plane.

According to some embodiments, the phase is estimated with a minimum error as the phase of the channel. According an embodiment, the phase estimation and the angle of rotation are determined in accordance with the above-mentioned methods.

In an embodiment, firstly phases θᵢ w.r.t real axis are determined. These phases represent different possible phase shifts that the received pilot symbol could have undergone due to channel effects. θᵣ is the angle of rotation, typically obtained from method explained w.r.t to the 16 QAM constellation. θᵢ is calculated by adding multiples of π/2 to θr.

$${θ}_{i} = {θ}_{r} + ( i - 1 ) π / 2 ; when {θ}_{r} > 0 ; Where i = 1 to 4 \qquad ( 7 )$$

$${θ}_{i} = {θ}_{r} + ( i ) π / 2 ; when θ r < 0 ; Where i = 1 to 4 \qquad ( 8 )$$

Further, angle θ_{Ls} us determined by comparing the received pilot symbol's phase with known reference phase using least square method. The angle θ_{Ls} is the phase of the channel determined by a least square method of the channel estimation. Further, a mean square error (MSE) is calculated. In an embodiment, the MSE values are calculated by taking a difference between each of the calculated phases θᵢ and θ_{Ls}. This quantifies phase difference computed from the estimated least square phase θ_{Ls}.

$$MSEi = ( θ i - θ Ls ) ; where i = 1 to 4$$

Further, the MSE values are compared. Thus, the calculated MSE values are compared to find the smallest one. The smallest MSE value indicates the phase closest to θ_{Ls}, thus providing an indication of the phase shift introduced by the channel. In an embodiment, a phase corresponding to minimum MSE is being determined. The phase θᵢ, where i=1 to 4 with the minimum MSE is selected. This phase is considered as the most accurate representation of the phase shift introduced by the channel.

In an embodiment, the phase selected is considered as the phase of the channel. In scenarios characterized by low SINRs, conventional channel estimation methods, such as the least squares technique, tend to outperform the disclosed channel estimation methods in accurately estimating the channel. Therefore, a judicious decision regarding the selection of an appropriate channel estimation method becomes imperative. In this context, the choice between disclosed and conventional channel estimation methods is based on the SINR level. A pivotal step in this process involves establishing a threshold SINR value, below which the conventional channel estimation method, such as least squares is more suitable. Conversely, above this threshold, the disclosed channel estimation methods are preferable.

In an embodiment, the following steps describe the procedure for estimating the SINR from the received data points and deciding whether to utilized conventional channel estimation methods or not. The threshold SINR is either known at the receiver or determined by the receiver by some mechanism. It can also be provided by the transmitter or by some other node or network. The receive data points are clustered using K-means clustering algorithm. Each cluster consists of one estimated centroid point. For each cluster, compute the Euclidean distance between its centroid point and each of its received constellation points. This distance represents how far each received symbol is from the centroid point. After calculating distances for all symbols in a cluster, find the mean of these distances in each cluster. The mean distance can be interpreted as the average noise level within that cluster. This depicts that the symbols are around the centroid point are dispersed. Further, an overall mean of the noise obtained from each cluster is determined. This gives an aggregate estimate of the noise present in the system, considering all clusters. Using the mean noise calculated along with the received signal power, the SINR of the system is computed. Further, the received signal power is calculated based on the transmitted signal power and the estimated amplitude of the channel. Based on the calculated SINR, an appropriate channel estimation method is determined: if SINR of the system is above a predefined threshold, e.g. for QPSK, 3 dB (SINR>3 dB), estimate the channel using the disclosed channel estimation methods. On the other hand, if SINR of the system is below a predefined threshold, e.g. for the QPSK, 3 dB (SINR<3 dB), estimate the channel using conventional channel estimation method like the least squares.

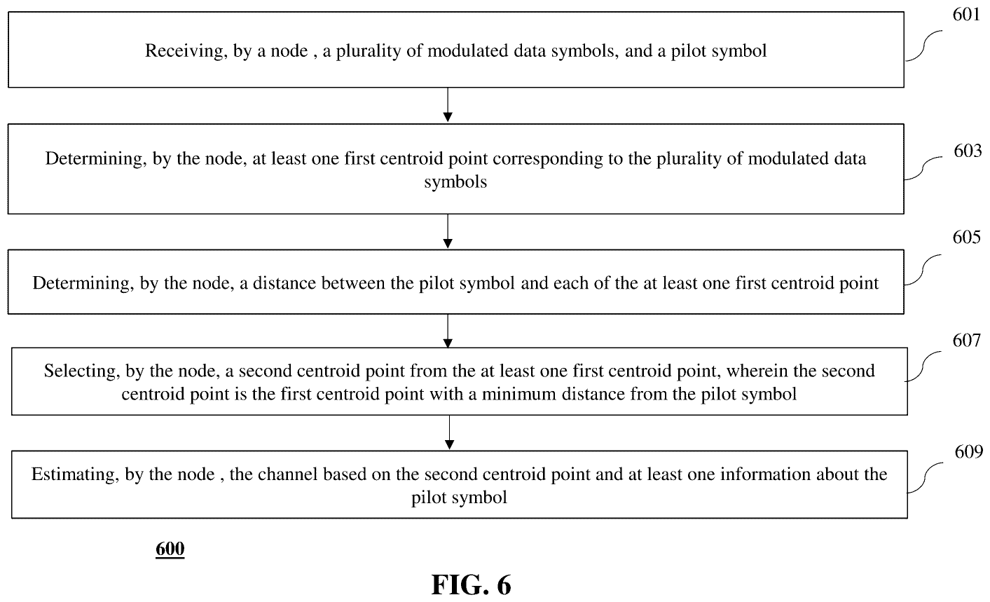

FIG. 6 illustrates a method 600 for estimating a channel in a wireless communication system, according to an embodiment of the present disclosure. According to an embodiment, the method 600 is deployed at a node. As an example, the node may include a user equipment (UE), routers, receiver, transmitter, and the like. An explanation of method 600 is being explained in above paragraphs, therefore for the sake of brevity a detailed explanation of the same is omitted here.

In an embodiment, at step 601, the node receives a plurality of modulated data symbols and a single pilot symbol. As an example, the plurality of modulated data symbols are one of the Quadrature Phase Shift Keying (QPSK), and the Quadrature Amplitude Modulation (QAM) modulated. Further, the pilot symbol is one of constellation points of the plurality of modulated data symbols. As an example, the received pilot symbol may be a reference signal which is transmitted by another node like a base station.

Further, at step 603, the node determines at least one first centroid point corresponding to the plurality of modulated data symbols. The at least one first centroid point corresponds to at least one ring in a modulation scheme of a known pilot symbol. In an embodiment, the first centroid point is determined by clustering the plurality of modulated data symbols into a plurality of clusters. Further, the first centroid point is determined by determining the at least one first centroid point as a mean of each cluster from the plurality of clusters. In an embodiment, the at least one first centroid point is determined using K-means clustering algorithm. In an embodiment, the at least one first centroid point is based on at least one of: the plurality of modulated data symbols, a modulation order, and at least one reference point.

In an embodiment, the at least one reference point is one of: constellation points corresponding to a modulation scheme of the known pilot symbol obtained by adding a plurality of phase shifts to one of: the pilot symbol, a known pilot symbol, or a data symbol with a minimum distance from the known pilot symbol. In an embodiment, the plurality of phase shifts are obtained as the integer multiple of one of a ratio of 27 and a number of constellation points in a ring corresponding to the modulation scheme and the modulation order.

According to some embodiments, the at least one reference point is obtained by: determining a difference between an angle of the known pilot symbol and an angle of the pilot symbol and rotating constellation points corresponding to a modulation scheme of the known pilot symbol by an angle. The angle of the known pilot symbol and the angle of the pilot symbol are with respect to the real axis.

According to an embodiment, at step 605, the node determines a distance between the pilot symbol and each of the at least one first centroid point. The distances between the received pilot symbol and each centroid point are computed. These distances are calculated using methods like Euclidean distance, depending on the system's specific requirements.

According to an embodiment, at step 607, the node selects a second centroid point from the at least one first centroid point, where the second centroid point is the first centroid point with a minimum distance from the pilot symbol.

According to an embodiment, at step 609, the node estimates the channel based on the second centroid point and at least one information about the pilot symbol.

In an embodiment, the at least one information about the pilot symbol is at least one of: a known pilot symbol, scheduling information of the known pilot symbol, the modulation scheme of the known pilot symbol, the modulation order of the known pilot symbol, a number of rings in the modulation scheme of the known pilot symbol, the ring corresponding to the known pilot symbol, an order of the known pilot symbol in the ring, a constellation point of the known pilot symbol, an angle of the known pilot symbol, an angle of the second centroid point, an average rotation angle, an order of the second centroid point in a ring, and a number of the at least one first centroid points in a ring. The at least one information about the pilot symbol can be explicitly received, implicitly derived, or predefined in the standards.

As an example, the order of the known pilot symbol in the ring is number corresponding to known pilot symbol. As explained above with reference to FIG. 4, the order of the known pilot symbol starts from the first quadrant and continues sequentially up to number of centroid points in the ring. For e.g., if number of centroid points in a ring is 8 than the pilot number starts from 1 and continues sequentially up to 8. the order of known pilot symbol will be one of the values from 1 to 8. Similarly, the order of the second centroid point in the ring is the number corresponding to the second centroid point. it starts from the first quadrant and continues sequentially up to number of centroid point in the ring. For e.g., if number of centroid points in a ring is 8 than the second centroid point number starts from 1 and continues sequentially up to 8. The order of second centroid point will be one of the values from 1 to 8.

In an embodiment, the node computes a magnitude and a phase of the channel to estimate the channel. As an example, the node obtains the magnitude of the channel using the magnitude of the at least one first centroid point. In an embodiment, the magnitude of the channel is one of a minimum, a maximum, and an average of the at least one first centroid point.

According to an embodiment, the node computes the phase of the channel based on an angle of the second centroid point with respect to the real axis and an angle of the known pilot symbol with respect to the real axis. In an embodiment, the phase of the channel is a difference between the angle of the second centroid point and the angle of the known pilot symbol when the difference is positive. On the other hand, the phase of the channel is a difference between the angle of the second centroid point and the angle of the known pilot symbol added with 2π when the difference is non-positive.

According to some embodiment, the node computes the phase of the channel by determining a number of rings in a complex plane based on a modulation scheme. Further, the node computes at least one rotation angle of at least one ring from a number of rings and then computes an average rotation angle from the at least one rotation angle.

In an embodiment, the average rotation angle is a weighted average of the rotation angle of the at least one ring. Further, the weight for the weighted average is determined based on a distance of the at least one ring from the origin.

In an embodiment, the node computes the at least one rotation angle of the at least one ring by determining at least one third centroid point, from the at least one first centroid point, overlapping with the at least one ring. Further, the node determines the angle of the at least one third centroid point with respect to the real axis. Further, the node computes an average of the angle of the at least one third centroid point.

In an embodiment, the node at step 609, further computes a phase factor corresponding to a ring from the at least one ring. Further, the node computes the phase of the channel as a sum of the phase factor and the average rotation angle when a difference between angle of the second centroid point and an angle of the known pilot symbol is greater than a zero. On the other hand, the node computes the phase of the channel as a sum of the phase factor, the average rotation angle and 2π when the difference between the angle of the second centroid point and the angle of the known pilot symbol is less than the zero.

In an embodiment, the phase factor is a product of a first factor and a second factor. The first factor is a difference between an order of the second centroid point in the ring and an order of the known pilot symbol in the ring. Further, the second factor is a ratio of 27r and a number of first centroid points in the ring. The ring from the at least one ring overlaps with the known pilot symbol.

In an embodiment, the node, at step 609, further determines a plurality of phases by adding a phase shift of integer multiple of π/2 to the average rotation angle. Further, the node further computes a plurality of errors between the plurality of phases and a reference phase. Further, the node determines a phase with a minimum error as the phase of the channel. In an embodiment, the plurality of errors are computed as a mean squared error.

In an embodiment, the integer multiple varies either from zero to three, when the average rotation angle is positive or the integer multiple varies from one to four, when the average rotation angle is negative. Further, the reference phase is obtained from the pilot symbol using a least square estimation.

According to an embodiment, the node computes a signal-to-interference plus noise ratio (SINR) value using the plurality of modulated data symbols. In particular, the node computes the SINR by computing a distance between the plurality of modulated data symbols in each of the plurality of clusters and the at least one first centroid point for each of the plurality of clusters. Further, the node determines a mean noise power by averaging the distance. Further, the node calculates a received signal power based on a transmitted signal power and the magnitude of the channel. Further, the node computes the SINR as a ratio of the received signal power and a mean noise power.

Thus, the present disclosure describes the channel estimation algorithms by using only a single RS/pilot. Estimating the channel using a single RS/pilot symbol offers a balance between overhead reduction, spectral efficiency, complexity, and robustness, making it a valuable approach in various the wireless communication scenarios.

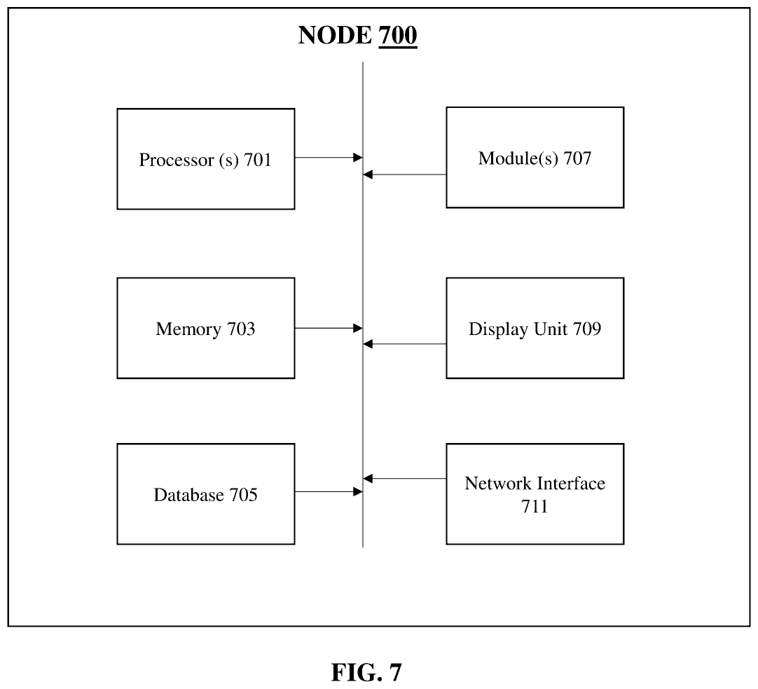

FIG. 7 illustrates a general block diagram of the node 700, according to an embodiment of the present disclosure. As an example, the node 700 may be any user equipment like smart phone, mobile, communicating with another node like a base station.

In an example, the processor(s) 701 may be a single processing unit or a number of units, all of which could include multiple computing units. The processor(s) 701 may be implemented as one or more microprocessors, microcomputers, microcontrollers, digital signal processors, central processing units, logical processors, virtual processors, state machines, logic circuitries, and/or any devices that manipulate signals based on operational instructions. Among other capabilities, the processor(s) 701 is configured to fetch and execute computer-readable instructions and data stored in a memory 703.

The memory 703 may include any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes.

The processors 701 may include one or more general purpose processors (e.g., INTEL® or Advanced Micro Devices® (AMD) microprocessors) and/or one or more special purpose processors (e.g., digital signal processors or Xilinx® System on Chip (SOC) Field Programmable Gate Array (FPGA) processor), MIPS/ARM-class processor, a microprocessor, a digital signal processor, an application specific integrated circuit, a microcontroller, a state machine, or any type of programmable logic array.

The memory 703 may include, but is no limited to, non-transitory machine-readable storage devices such as hard drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions.

In an example, the module(s), engine(s), and/or unit(s) 707 may include a program, a subroutine, a portion of a program, a software component or a hardware component capable of performing a stated task or function. As used herein, the module(s), engine(s), and/or unit(s) may be implemented on a hardware component such as a server independently of other modules, or a module can exist with other modules on the same server, or within the same program. The module (s), engine(s), and/or unit(s) 707 may be implemented on a hardware component such as processor one or more microprocessors, microcomputers, microcontrollers, digital signal processors, central processing units, state machines, logic circuitries, and/or any devices that manipulate signals based on operational instructions. The module (s), engine(s), and/or unit(s) 707 when executed by the processor(s) 701 may be configured to perform any of the described functionalities.

As a further example, the database 705 may be implemented with integrated hardware and software. The hardware may include a hardware disk controller with programmable search capabilities or a software system running on general-purpose hardware. Examples of databases are but are not limited to, in-memory databases, cloud databases, distributed databases, embedded databases, and the like. The database amongst other things, serves as a repository for storing data processed, received, and generated by one or more of the processors(s) 701, and the modules/engines/units.

The modules/engines/units 707 may be implemented with an AI module that may include a plurality of neural network layers. Examples of neural networks include, but are not limited to, a convolutional neural network (CNN), a deep neural network (DNN), a recurrent neural network (RNN), a Restricted Boltzmann Machine (RBM). The learning technique is a method for training a predetermined target device using a plurality of learning data to cause, allow, or control the target device to decide or prediction. Examples of the learning techniques include, but are not limited to, a supervised learning, unsupervised learning, a semi-supervised learning, or reinforcement learning. At least one of a plurality of CNN, DNN, RNN, RMB models and the like may be implemented to thereby achieve execution of the present subject matter's mechanism through an AI model. A function associated with the AI model may be performed through the non-volatile memory, the volatile memory, and the processor. The processor may include one or a plurality of processors. At this time, one or a plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The one or a plurality of processors control the processing of the input data in accordance with a predefined operating rule or the artificial intelligence (AI) model stored in the non-volatile memory and the volatile memory. The predefined operating rule or artificial intelligence model is provided through training or learning.

As an example, the display unit 709 includes a computer monitor, a touch screen, an output device capable of displaying the graphics, and the like. The display unit 909 is configured to display visual output in the UEs, desktops, laptops, and workstations. The display unit 909 may come in different sizes, resolutions, and types (such as LCD, LED, or OLED).

As a further example, the network interface 711 is configured to provide and establish communication with any electronic device via a public network, private network, or any wireless communication technology.

The figures of the disclosure are provided to illustrate some examples of the invention described. The figures are not to limit the scope of the depicted embodiments or the appended claims. Aspects of the disclosure are described herein with reference to the invention to example embodiments for illustration. It should be understood that specific details, relationships, and method are set forth to provide a full understanding of the example embodiments. One of ordinary skill in the art recognize the example embodiments can be practiced without one or more specific details and/or with other methods.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Aspects of the present disclosure may be implemented as computer program products that comprise articles of manufacture. Such computer program products may include one or more software components including, for example, applications, software objects, methods, data structure, and/or the like. In some embodiments, a software component may be stored on one or more non-transitory computer-readable media, which computer program product may comprise the computer-readable media with software component, comprising computer executable instructions, included thereon. The various control and operational systems described herein may incorporate one or more of such computer program products and/or software components for causing the various conveyors and components thereof to operate in accordance with the functionalities described herein.

A software component may be coded in any of a variety of programming languages. An illustrative programming language may be a lower-level programming language such as an assembly language associated with a particular hardware architecture and/or operating system platform/system. Other example of programming languages included, but are not limited to, a macro language, a shell or command language, a job control language, a script language, a database query, or search language, and/or report writing language. In one or more example embodiments, a software component comprising instructions in one of the foregoing examples of programming languages may be executed directly by an operating system or other software component without having to be first transformed into another form. A software component may be stored as a file or other data storage methods. Software components of a similar type or functionally related may be stored together such as, for example, in a particular directory, folder, or repository. Software components may be static (e.g., pre-established, or fixed) or dynamic (e.g., created or modified at the time of execution).

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

It is to be understood that the disclosure is not to be limited to the specific embodiments disclosed, and that modifications and other embodiments are intended to be included within the scope of the appended claims. Although specific terms are employed herein, they are used in a generic and descriptive sense only and not for purposes of limitation, unless described otherwise.

The terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

Any combination of the above features and functionalities may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set as claimed in claims that issue from this application, in the specific form in which such claims issue, including any subsequent correction.

We claim:

1. A method for estimating a channel in a wireless communication system, the method comprises:
receiving, by a node, a plurality of modulated data symbols, and a pilot symbol;
determining, by the node, at least one first centroid point corresponding to the plurality of modulated data symbols;
determining, by the node, a distance between the pilot symbol and each of the at least one first centroid point;
selecting, by the node, a second centroid point from the at least one first centroid point, wherein the second centroid point is the first centroid point with a minimum distance from the pilot symbol; and
estimating, by the node, the channel based on the second centroid point and at least one information about the pilot symbol.

2. The method as claimed in claim 1, wherein the at least one information about the pilot symbol is at least one of:
a known pilot symbol,
scheduling information of the known pilot symbol,
modulation scheme of the known pilot symbol,
modulation order of the known pilot symbol,
a number of rings in the modulation scheme of the known pilot symbol,
a ring corresponding to the known pilot symbol,
an order of the known pilot symbol in the ring,
a constellation point of the known pilot symbol,
an angle of the known pilot symbol,
an angle of the second centroid point,
an average rotation angle,
an order of the second centroid point in a ring, and
a number of the at least one first centroid points in a ring.

3. The method as claimed in claim 1, wherein the at least one information about the pilot symbol is at least one of explicitly received, implicitly derived, and predefined in standards.

4. The method as claimed in claim 1, wherein estimating the channel comprises:
computing a magnitude and a phase of the channel.

5. The method as claimed in claim 4, wherein the magnitude of the channel is obtained using the magnitude of the at least one first centroid point.

6. The method as claimed in claim 5, wherein the magnitude of the channel is one of a minimum, a maximum, and an average of the at least one first centroid point.

7. The method as claimed in claim 4, wherein the at least one first centroid point corresponds to at least one ring in a modulation scheme of a known pilot symbol.

8. The method as claimed in claim 1, wherein the plurality of modulated data symbols are one of a Quadrature Phase Shift Keying (QPSK), and a Quadrature Amplitude Modulation (QAM) modulated.

9. The method as claimed in claim 4, wherein
computing the phase of the channel is based on an angle of the second centroid point with respect to a real axis and an angle of the known pilot symbol with respect to the real axis.

10. The method as claimed in claim 9, wherein the phase of the channel is one of:
a difference between the angle of the second centroid point and the angle of the known pilot symbol when the difference is positive, and
a difference between the angle of the second centroid point and the angle of the known pilot symbol added with 2π when the difference is non-positive.

11. The method as claimed in claim 1, wherein determining the at least one first centroid point comprises:
clustering the plurality of modulated data symbols into a plurality of clusters.

12. The method as claimed in claim 11, further comprises:
determining the at least one first centroid point as a mean of each cluster from the plurality of clusters.

13. The method as claimed in claim 1, wherein determining the at least one first centroid point is using K-means clustering algorithm.

14. The method as claimed in claim 1, wherein determining the at least one first centroid point is based on at least one of:
the plurality of modulated data symbols, a modulation order and at least one reference point.

15. The method as claimed in claim 14, wherein the at least one reference point is one of:
constellation points corresponding to a modulation scheme of a known pilot symbol obtained by adding a plurality of phase shifts to one of:
the pilot symbol, the known pilot symbol, or a data symbol with a minimum distance from the known pilot symbol.

16. The method as claimed in claim 15, wherein the plurality of phase shifts obtained as the integer multiple of one of:
a ratio of 2π and a number of constellation points in a ring corresponding to the modulation scheme and
the modulation order.

17. The method as claimed in claim 14, wherein the at least one reference point is obtained by:
determining a difference between an angle of the known pilot symbol and an angle of the pilot symbol and
rotating constellation points corresponding to a modulation scheme of a known pilot symbol by an angle.

18. The method as claimed in claim 17, wherein the angle of known pilot symbol and the angle of the pilot symbol are with respect to a real axis.

19. The method as claimed in claim 1, wherein the pilot symbol is one of constellation points of the plurality of modulated data symbols.

20. The method as claimed in claim 4, wherein computing the phase of the channel comprises:
determining a number of rings in a complex plane based on a modulation scheme;
computing at least one rotation angle of at least one ring from a number of rings; and
computing an average rotation angle from the at least one rotation angle.

21. The method claimed in claim 20, wherein the average rotation angle is a weighted average of the rotation angle of the at least one ring.

22. The method claimed in claim 21, wherein a weight for the weighted average is determined based on a distance of the at least one ring from an origin.

23. The method as claimed in claim 20, wherein computing the at least one rotation angle of the at least one ring comprises:
determining at least one third centroid point, from the at least one first centroid point, overlapping with the at least one ring;
determining the angle of the at least one third centroid point with respect to a real axis; and
computing an average of the angle of the at least one third centroid point.

24. The method as claimed in claim 20, further comprises:
computing a phase factor corresponding to a ring from the at least one ring; and
computing the phase of the channel as one of:
a sum of the phase factor and the average rotation angle when a difference between angle of the second centroid point and an angle of the known pilot symbol is greater than a zero; and
a sum of the phase factor, the average rotation angle and 2π when the difference between the angle of the second centroid point and the angle of the known pilot symbol is less than the zero.

25. The method as claimed in claim 24, wherein the phase factor is a product of a first factor and a second factor,
wherein the first factor is a difference between an order of the second centroid point in the ring and an order of the known pilot symbol in the ring, and
wherein the second factor is a ratio of 2π and a number of first centroid points in the ring.

26. The method as claimed in claim 24, wherein the ring from the at least one ring overlaps with the known pilot symbol.

27. The method claimed in claim 20, further comprises:
determining a plurality of phases by adding a phase shift of integer multiple of π/2 to the average rotation angle;
computing a plurality of errors between the plurality of phases and a reference phase; and
determining a phase with a minimum error as the phase of the channel.

28. The method claimed in claim 27, wherein the integer multiple varies from one of:
zero to three, when the average rotation angle is positive, and
one to four, when the average rotation angle is negative.

29. The method claimed in claim 27, wherein the reference phase is obtained from the pilot symbol using a least square estimation.

30. The method claimed in claim 27, wherein the plurality of errors are computed as a mean squared error.

31. The method as claimed in claim 1, further comprises:
computing a signal-to-interference plus noise ratio (SINR) value using the plurality of modulated data symbols.

32. The method as claimed in claim 31, wherein computing the SINR value comprises:
computing a distance between the plurality of modulated data symbols in each of a plurality of clusters and the at least one first centroid point for each of the plurality of clusters;
determining a mean noise power by averaging the distance;
calculating a received signal power based on a transmitted signal power and the magnitude of the channel; and
computing the SINR as a ratio of the received signal power and a mean noise power.
